(19) United States
(12) Patent Application Publication
(10) Pub. No.: US 2015/0377435 A1
(43) Pub. Date: Dec. 31, 2015

(54) ILLUMINATION APPARATUS USING SUNLIGHT

(71) Applicant: NATIONAL CENTRAL UNIVERSITY, TAOYUAN COUNTY (TW)

(72) Inventors: CHENG-YI LIU, TAOYUAN COUNTY (TW); CHIH-YI HSIEH, TAIPEI CITY (TW); WEI-CHIH LIU, TAOYUAN COUNTY (TW)

(21) Appl. No.: 14/315,446

(22) Filed: Jun. 26, 2014

(51) Int. Cl. F21S 11/00; F21V 23/00; F21K 99/00; F21V 29/70; F21V 8/00; F21V 5/04

(52) U.S. Cl. CPC F21S 11/007; G02B 6/0006; F21V 5/048; F21K 9/56; F21V 29/70; F21V 23/003; F21Y 2101/02

(57) ABSTRACT

An illumination apparatus includes a sunlight guide member, a light emitting device, a wavelength converting element, a fiber-optic light guide connecting the light emitting device and the wavelength converting element, and a lighting control system for controlling the light emitting diode. The sunlight guide member is provided to guide outdoor sunlight to an indoor area. The light emitting device is provided for generating light having a first wavelength range along a beam path. The wavelength converting element is disposed in the beam path and physically separated from the light emitting device. The wavelength converting element converts the light emitted by the light emitting device with the first wavelength range into light having a second wavelength range. The lighting control system is configured to detect an intensity of the outdoor sunlight and to control radiance of the light emitting device according to the detected intensity of the outdoor sunlight.

### BACKGROUND OF THE INVENTION

1. Field of the Invention

The present invention relates to an illumination apparatus, and more particularly to an environment friendly illumination apparatus using the light emitting diodes as well as sunlight.

2. Description of the Related Art

One type of illumination apparatus 900 is illustrated in FIG. 3, in which variable color temperatures of light are provided. The illumination apparatus 900 comprises a light module 7, a driving module 8 and a control module 9. The driving module 8 connects the light module 7 and the control module 9. The control module 9 is configured for control of the driving module 8 to determine the brightness and color temperature of the light produced by the illumination apparatus 900.

Specifically, the light module 7 includes a single first lighting device 71 and a plurality of second lighting devices 72. The driving module 8 includes one a first driving unit 81 and a second driving unit 82. The first driving unit 81 of the driving module 8 has a plurality of first drivers 811 all connected to the first lighting device 71. The second driving unit 82 of the driving module 8 has a plurality of second drivers 821 respectively connected to the second lighting devices 72. The control module 9 controls the first driving unit 81 to determine the brightness of the illumination apparatus 900. The control module 9 also controls the second driving unit 82 to determine the color temperature of the light produced by the illumination apparatus 900.

### SUMMARY OF THE INVENTION

It is an object of the present invention to provide a new, environment friendly illumination apparatus which employs sunlight to assist the lighting.

Accordingly, the present invention is directed to an illumination apparatus which comprises a sunlight guide member, a first light emitting device, a first wavelength converting element, a first fiber-optic light guide and a lighting control system. The sunlight guide member is provided to guide outdoor sunlight to an indoor area. The first light emitting device is provided for generating light having a first wavelength range along a first beam path. The first wavelength converting element is disposed in the first beam path and physically separated from the first light emitting device. The wavelength converting element converts the light emitted by the first light emitting device with the first wavelength range into light having a second wavelength range. The first fiber-optic light guide is disposed along the first beam path for guiding the light emitted by the first light emitting device to the first wavelength converting element. The lighting control system is configured to detect an intensity of the outdoor sunlight and to control radiance of the first light emitting device according to the detected intensity of the outdoor sunlight.

Preferably, the illumination apparatus further comprises a second light emitting device, a second wavelength converting element and a second fiber-optic light guide. The second light emitting device is provided for generating light having a third wavelength range along a second beam path. The second wavelength converting element is disposed in the second path and physically separated from the second light emitting device for converting the light emitted by the second light emitting device with the third wavelength range into light having a fourth wavelength range that differs from the second wavelength range. The second fiber-optic light guide is disposed along the second beam path for guiding the light emitted by the second light emitting device to the second wavelength converting element. Moreover, the lighting control system is further configured to control radiance of the second light emitting device so as to adjust a color temperature of the light produced by the illumination device.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an illumination device in accordance with the preferred embodiment of the present invention;

FIG. 2 is a block diagram of the illumination device in FIG. 1; and

FIG. 3 is a prior art.

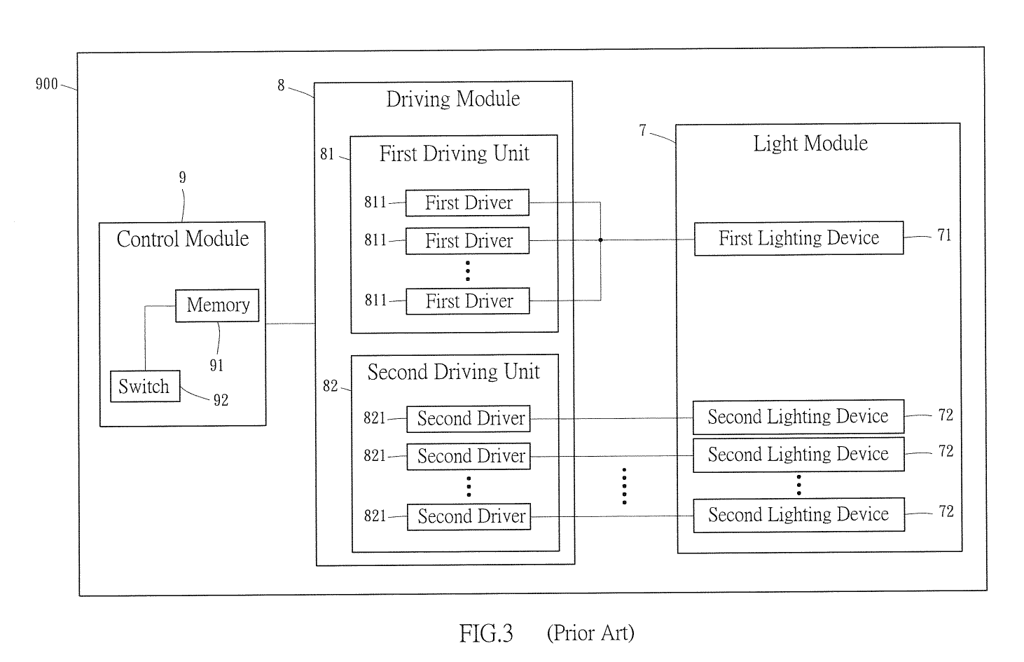

### DETAILED DESCRIPTION OF PREFERRED EMBODIMENT

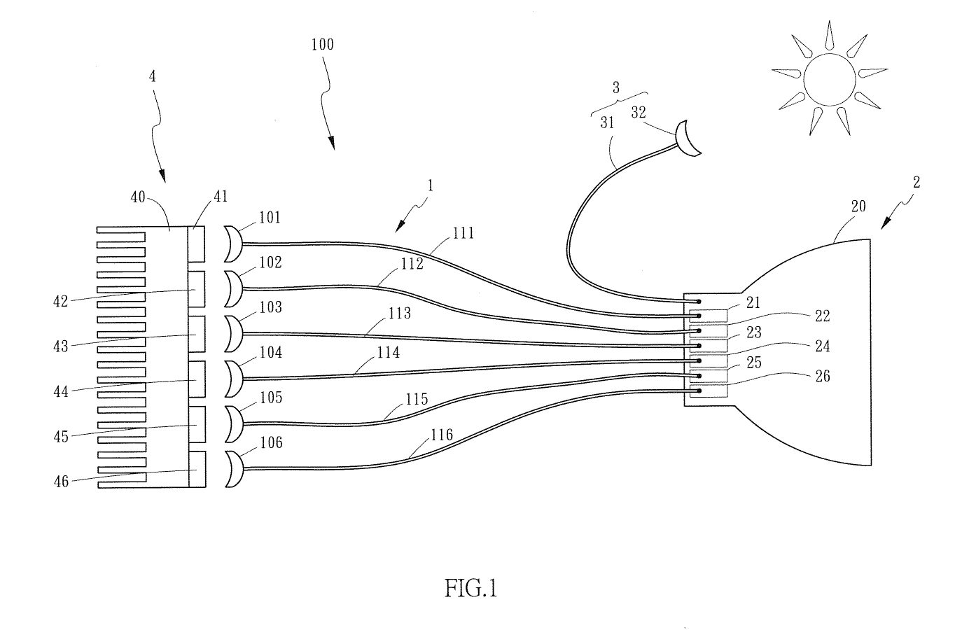

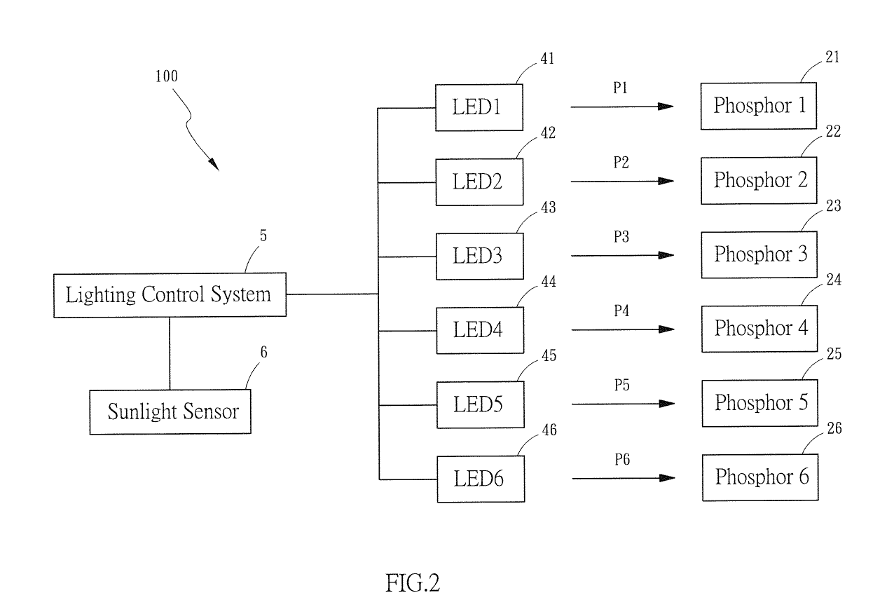

Referring to FIGS. 1 and 2, there is shown the preferred embodiment of the illumination apparatus 100, which comprises a first optical module 1, a second optical module 2, a third optical module 3, a LED module 4, and a lighting control system 5 (see FIG. 2).

As shown in FIG. 1, the LED module 4 includes a plurality of light emitting devices 41-46 and a heat sink 40 on which the light emitting devices 41-46 are mounted. It is understood that the heat sink 40 is provided for dissipating heat generated by the light emitting devices 41-46. The light emitting devices 41-46 are provided for generating light along beam paths P1-P6 to the second optical module 2. The light emitting devices 41-46 may be identical to generate light having the same wavelength range. Alternatively, the light emitting devices 41-46 may provide different colors with different wavelength ranges as required.

The first optical module 1 includes a plurality of converging lenses 101-106 and a plurality of flexible fiber optic light guides 111-116. Thus, it is preferred that the light emitting devices 41-46 have high-directivity properties so that the light emitted by the light emitting devices 41-46 can be easily guided into the fiber optic light guides 111-116. The converging lenses 201-206 are arranged to assist the light emitted by the light emitting devices 11-16 into the fiber optic light guides 111-116. The light guides 111-116 are respectively disposed along the beam paths P1-P6 for guiding the light to the respective wavelength converting elements 21-26 in the light output unit 20.

The second optical module 2 includes a light output unit 20 and a plurality of wavelength converting elements 21-26 disposed in the light output unit 20. The wavelength converting elements 21-26, such as phosphors, are disposed in the respective beam paths P1-P6 and physically separated from the light emitting devices 41-46. Accordingly, the temperature limitations of the wavelength converting elements 21-26 will no longer place a limitation on the radiance of the light emitting devices 41-46. The light converted by the wavelength converting elements 21-26 is then output through the light output unit 20. Preferably, the light emitting devices 41-46 are blue LEDs for all the wavelength converting elements 21-26; and the wavelength converting elements 21-26 have different phosphor materials for converting the light emitted by the light emitting devices 41-46 into light with different wavelength ranges. That is, the wavelength converting elements 21-26 converted the light with a single color from the light guides 111-116 into light with different colors to be blended.

Preferably, the wavelength converting elements 21-26 are detachably connected to the respective light guides 111-116 such that the wavelength converting elements 21-26 may be easily interchanged with one another or other wavelength converting elements to create a desired color temperature of the light produced by the illumination apparatus 100.

The third optical module 3 includes a sunlight guide member 31, such as a fiber optic light guide, for guiding outdoor sunlight into an indoor area. Specifically, the sunlight guide member 31 is connected with the light output unit 20 for guiding the outdoor sunlight to the light output unit 20. A converging lens 32 may be employed to associate with the sunlight guide member 31 to efficiently direct the outdoor sunlight to the light output unit 20 for illumination of the indoor area.

The lighting control system 5 is configured to detect an intensity of the outdoor sunlight by means of a sunlight sensor 6 connected thereto, and to control radiance or brightness of the light emitting devices 41-46 according to the detected intensity of the outdoor sunlight. Note that the sunlight sensor 6 may be placed in the outdoor to detect the intensity of the sunlight, and wirely or wirelessly connected to the lighting control system 5 for transmitting the detected intensity data to the lighting control system 5.

The lighting control system 5 is further configured to control radiance of the light emitting devices 41-46 so as to have the respective wavelength converting elements 21-26 emitting different colors of light that is blended to create a desired color temperature. In other words, the lighting control system 5 may be operated to adjust the color temperature of the light produced by the illumination device.

What is claimed is:

1. An illumination apparatus comprising:
a sunlight guide member provided to guide outdoor sunlight to an indoor area;
a first light emitting device provided for generating light having a first wavelength range along a first beam path;
a first wavelength converting element disposed in the first beam path and physically separated from the first light emitting device for converting the light emitted by the first light emitting device with the first wavelength range into light having a second wavelength range;
a first light guide disposed along the first beam path for guiding the light emitted by the first light emitting device to the first wavelength converting element; and
a lighting control system configured to detect an intensity of the outdoor sunlight and to control radiance of the first light emitting device according to the detected intensity of the outdoor sunlight.

2. An illumination apparatus as recited in claim 1, wherein the first light guide is fiber-optic.

3. An illumination apparatus as recited in claim 2, further comprising a first converging lens associated with the first light emitting device to direct the light emitted by the first light emitting device into the first light guide.

4. An illumination apparatus as recited in claim 1, wherein the sunlight guide member is fiber-optic.

5. An illumination apparatus as recited in claim 4, further comprising a converging lens associated with the sunlight guide member to direct the outdoor sunlight into the sunlight guide member.

6. An illumination apparatus as recited in claim 4, further comprising a light output unit, wherein the first wavelength converting element is disposed in the light output unit such that the light converted by the first wavelength converting element is output through the light output unit, and the sunlight guide member is connected with the light output unit for guiding the outdoor sunlight to the light output unit.

7. An illumination apparatus as recited in claim 1, wherein the first wavelength converting element is detachably connected to the first light guide.

8. An illumination apparatus as recited in claim 1, further comprising:
a second light emitting device provided for generating light having a third wavelength range along a second beam path;
a second wavelength converting element disposed in the second path and physically separated from the second light emitting device for converting the light emitted by the second light emitting device with the third wavelength range into light having a fourth wavelength range that differs from the second wavelength range; and
a second light guide disposed along the second beam path for guiding the light emitted by the second light emitting device to the second wavelength converting element; and
wherein the lighting control system is further configured to control radiance of the second light emitting device so as to adjust a color temperature of the light produced by the illumination device.

9. An illumination apparatus as recited in claim 8, further comprising a heat sink on which the first and second light emitting devices are disposed.

10. An illumination apparatus as recited in claim 8, wherein the first wavelength range of the light emitted by the first light emitting device is different from the third wavelength range of the light emitted by the second light emitting device.

11. An illumination apparatus as recited in claim 8, wherein the first wavelength range of the light emitted by the first light emitting device is substantially identical to the third wavelength range of the light emitted by the second light emitting device.

12. An illumination apparatus as recited in claim 11, wherein the first and the second light emitting devices are blue LEDs.

13. An illumination apparatus as recited in claim 1, further comprising a sunlight sensor coupled to the lighting control system for detecting the intensity of the outdoor sunlight and transmitting the detected intensity data to the lighting control system.
